(19) United States
(12) Patent Application Publication
(10) Pub. No.: US 2008/0296217 A1
(43) Pub. Date: Dec. 4, 2008

(54) Porous Monolithic Support for a Filtering Element

(75) Inventors: Valérie Thoraval, Morance (FR); Pascal Bouteyre, Fontaine Sur Saone (FR); Patrick Notargiacomo, Beligneux (FR); Alain Wallart, St Martin La Plaine (FR)

Correspondence Address: MARSH, FISCHMANN & BREYFOGLE LLP, 8055 East Tufts Avenue, Suite 450, Denver, CO, 80237, US

(73) Assignee: ORELIS, Miribel (FR)

(21) Appl. No.: 11/577,496

(22) PCT Filed: Oct. 21, 2005
(86) PCT No.: PCT/FR05/02622

§ 371 Date: Apr. 18, 2007

(30) Foreign Application Priority Data
Oct. 27, 2004 (FR) 0411471

(51) Int. Cl. B01D 63/06; B01D 69/10; B01D 69/04

(52) U.S. Cl. 210/484

(57) ABSTRACT

The invention relates to a porous monolith support (50) for a filtration element, having a tubular shape and an essentially-constant cross-section along the axis thereof (X-X). The inventive support comprises a plurality of channels (62, 64), the surfaces of which are intended to be covered with filtration membranes. According to the invention, the cross-sections of the channels are distributed inside the cross-section of the support and said channels (62, 64) are only separated from the periphery of the support by a single lateral wall (56) of the support. Moreover, all of the channels of the support are distributed as follows: in a first group of oblong radial channels (62) which are disposed such that the length thereof extends in an essentially-radial manner, and in a second group of oblong lateral channels (64) which are positioned between the radial channels (62) and which are disposed such that the length thereof extends essentially parallel to the periphery of the support.

The present invention relates to a porous monolithic support for a filtering element having a tubular shape and a substantially constant cross section along the direction of its axis and comprising a plurality of channels the surfaces of which are intended to be covered with filtration membranes, these channels having cross sections distributed in the cross section of the support, all the channels being separated from the periphery of the support only by a single lateral wall of the support.

A filtering element comprises a porous monolithic support through which longitudinal channels pass the lateral surface of which is covered with a filtering membrane having a very small thickness and defining filtering meshes of a given size. According to the membrane used, such a filtering element allows the implementation in a liquid medium of a method of filtration, microfiltration, ultrafiltration, nanofiltration or reverse osmosis.

During the filtration, the fluid to be filtered circulates in the channels in the form of tangential currents on contact with the filtration membranes. The membranes ensure separation of the circulating liquid medium in contact with them by retaining certain particles or molecules and allowing other fractions of the liquid medium to flow through when they are subjected to a pressure produced on both sides of the membranes called transmembrane pressure.

Since the membranes are of very reduced thickness, they are very fragile. The porous monolithic support ensures the mechanical strength of the filtering element so that membranes with a very small thickness can be used.

The channels are distributed in the section of the monolithic support according to a specific arrangement.

This arrangement, as well as the size and the shape of the channels, are chosen as a function of different constraints, and in particular the viscosity of the fluid to be filtered, with the objective of making the filtering surface produced as large as possible, i.e. the filtering membrane surface available to the fluid for a reduced volume of the filtering element, i.e. a reduced volume of the monolithic support.

However, the hydraulic diameter of the channels, defined by four times the surface of the cross section of a channel divided by its perimeter, must be sufficiently large to allow a satisfactory flow of the fluid to be filtered in the channel, in particular in the case where the fluid to be filtered is viscous or loaded with matter in suspension.

Thus a monolithic support is known, for example from document FR-A-2,724,850, which discloses channels with sections being formed by sectors of disk distributed over a circle in a regular manner around its axis. The number of channels is commonly comprised between three and six.

In order to increase the filtering surface produced, it is known to increase the number of channels. In particular, the channels can be distributed over several concentric circumferences centred along the axis of the filtering support. However, in a multichannel filtering element, the permeate, i.e. the fluid having passed through the membrane circulates inside the porous walls of the monolithic support in order to be directed towards the external surface of the support. The circulation conditions of the permeate are therefore very different according to the position in the section of the filtering element of the channel which the permeate comes from. Thus, the porous monolithic supports, of which all the channels are separated from the periphery of the support only by a single lateral wall of the support are preferred.

The arrangements as described in document FR-2,724,850, in which the channels are constituted by generally triangular sectors offset angularly (with rounded square angles) and distributed on the same circumference do not always produce satisfactory performances when the diameter of the monolithic support is significant, for example of the order of 25 mm. In fact, if the number of channels is reduced, the filtering surface produced can be small and if the number of channels is high, these are relatively flat, such that the hydraulic diameter of the channels is reduced and can prove to be insufficient for the circulation of certain viscous fluids.

Thus, the purpose of the invention is to propose a porous monolithic support wherein the geometry and the arrangement of the channels make it possible to optimize the membrane surface produced while retaining a sufficient hydraulic diameter, in particular in order to filter viscous fluids or highly loaded suspensions, and make it possible to obtain high filtration performance, even with monolithic supports having a large external diameter.

For this purpose the subject of the invention is a porous monolithic support, of the aforementioned type, characterized in that all the channels of the support are distributed in:
a first set of radial oblong channels arranged with their length extending substantially radially; and
a second set of lateral oblong channels inserted between the radial channels and arranged with their length extending substantially parallel to the periphery of the support.

According to particular embodiments, the porous monolithic support comprises one or more of the following characteristics:
the number of radial channels and lateral channels is comprised between 8 and 12;
the length of the radial channels is greater than quarter of the minimum transverse dimension of the support;
the surface area of the cross-section of the radial and lateral channels is comprised between 18 and 30 mm²;
the width of the radial channels is comprised between 0.3 and 0.6 times their length;
the minimum transverse dimension of the support is comprised between 24 mm and 30 mm, and the hydraulic diameter of each channel is comprised between 4 and 6 mm;
all the radial and lateral channels have the same shape;
the radial channels have a section in the shape of an ellipse;
the radial channels have a section in the shape of a curvilinear triangle having a large convex side and two smaller concave sides;
the lateral channels are arranged such that the large convex sides of their section extend substantially parallel to the periphery of the support;
the radial channels have a polygonal shape with at least four sides, and the lateral channels have a generally triangular shape;
the channels are disjoint;
the support comprises, for each pair of adjacent channels constituted by a radial channel and by a lateral channel a connecting passage ensuring communication between the associated radial and lateral channels; and
each connecting passage has a width less than half of the smallest length of the channels.

A subject of the invention is also a filtering element comprising a porous monolithic support delimiting a plurality of channels and filtration membranes covering the walls of the channels, characterized in that the porous monolithic support is as defined above.

The invention also relates to a fluid filtration module comprising a set of filtering elements in accordance with that defined previously.

The invention will be better understood on reading the following description, given only by way of example, and referring to the drawings, in which:

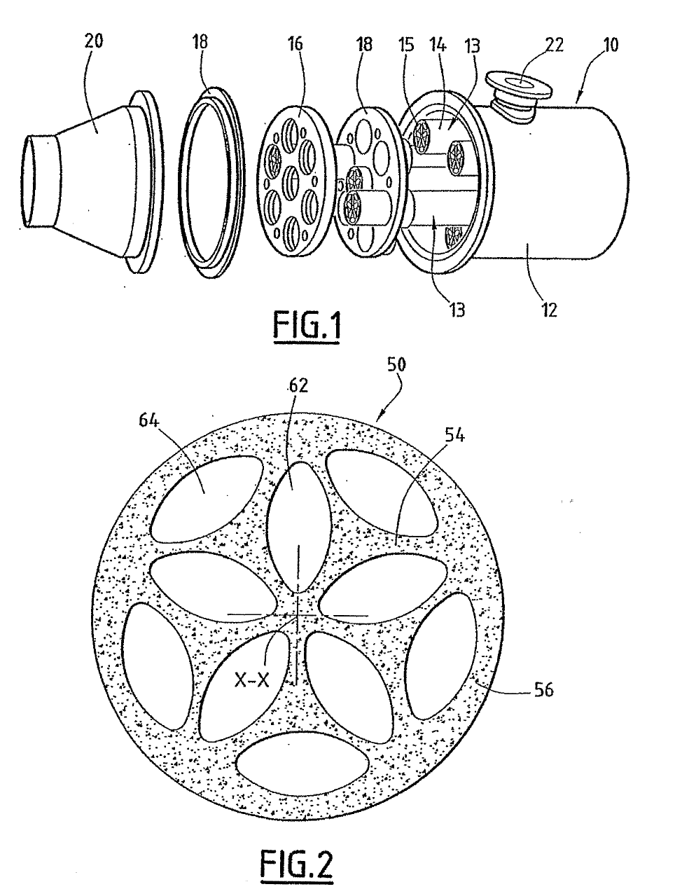

FIG. 1 is a perspective exploded partial view of a filtration module comprising the porous supports according to the invention;

FIG. 2 is a section of a porous monolithic support according to the invention;

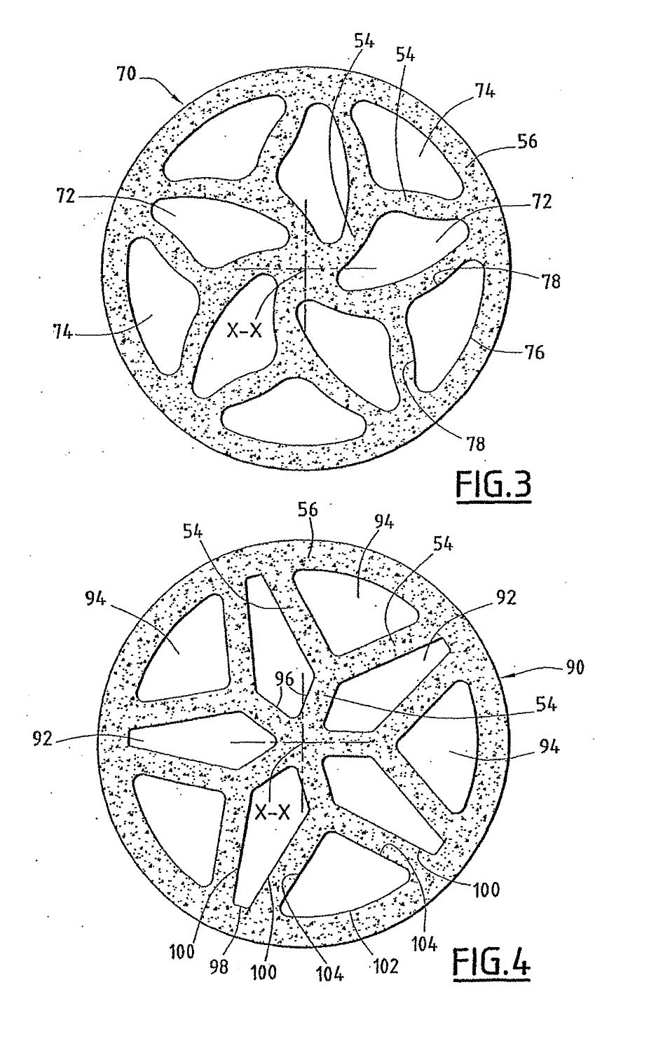

FIGS. 3 and 4 are views identical to that of FIG. 2 of other variant embodiments of a porous monolithic support according to the invention;

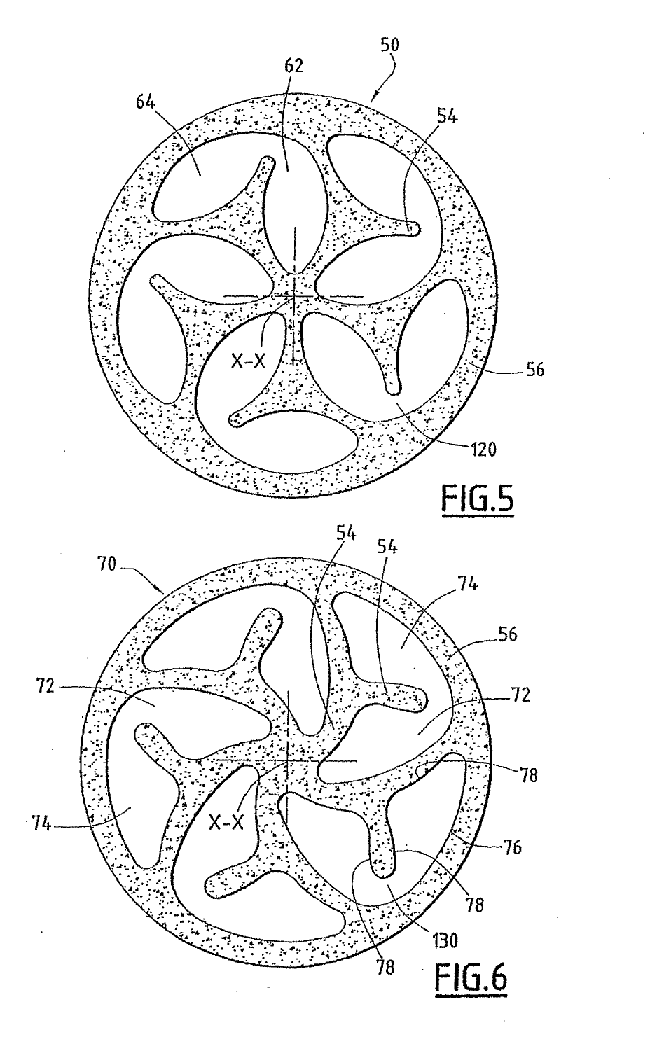

FIGS. 5, 6 and 7 are views identical to those of FIGS. 2, 3 and 4 showing variant embodiments of the respective monolithic supports of these figures; and

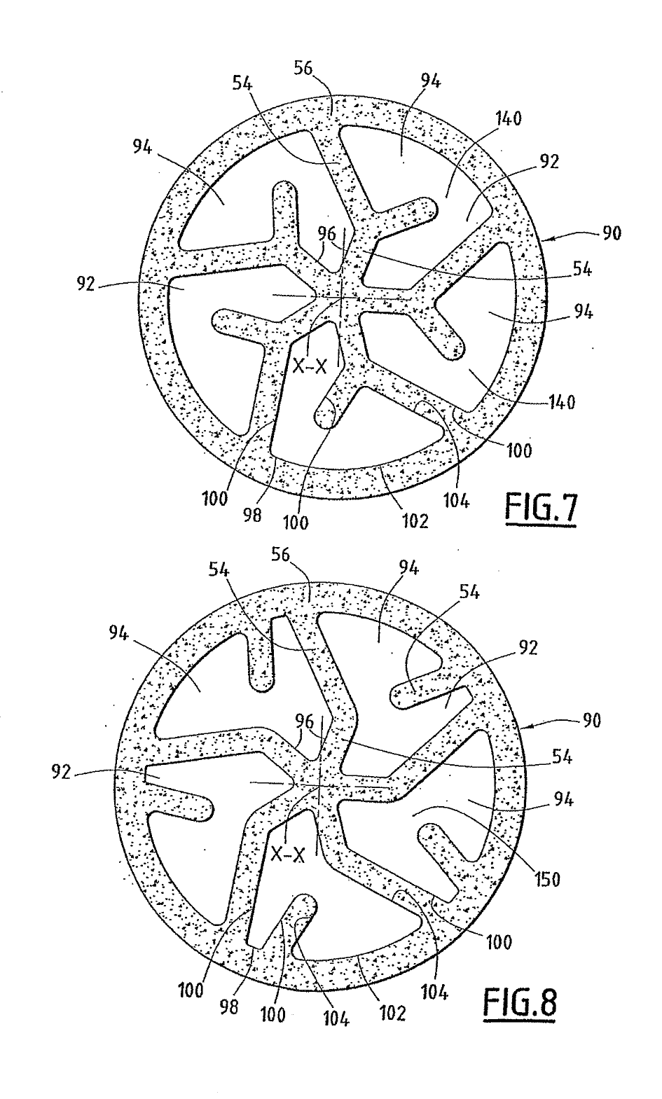

FIG. 8 is a view identical to that of FIG. 7 of yet another variant embodiment.

The filtration module 10 illustrated in FIG. 1 comprises a tubular body 12 in which filtration elements 13 are arranged parallel to each other formed by porous monolithic supports 14 according to the invention the internal channels of which are covered with a porous membrane 15. At each end, the porous monolithic supports are held by spacer 16 with which seals 18 are associated. The body 12 is extended at its ends by convergent sections 20 one of which forms an inlet for the fluid to be filtered and the other of which forms an outlet for collection of the retentate, i.e. of the fluid not having passed through the porous membranes. One or more lateral branch connections 22 are provided on the body 12 for collection of the permeate having passed through the porous membranes.

As is known per se, during a filtering operation in such a filtration module, the fluid to be filtered is taken to the inside of the filtration channels. A pressure difference is established between the internal part of the channels holding the membranes and the chamber formed outside the supports 14 and delimited by the body 12. Thus, a fraction of the fluid to be filtered passes through the filtration membranes and circulates through the porous support 14 in the direction of their external surface.

The monolithic support according to the invention is preferably made of a porous ceramic material. It is formed from a single part, for example by a standard process of extrusion of a ceramic material through a die of a suitable shape forming the network of walls separating the channels.

After firing the ceramic material, the internal surface of the channels is covered with a thin layer of a substance allowing a filtering layer or membrane to be obtained on the surface of each of the channels by sintering.

FIG. 2 shows a section of a porous monolithic support 50 according to the invention. The latter has a cylindrical tubular shape with an axis X-X with a circular section. The diameter of the support is, preferably, comprised between 20 mm and 30 mm and is, for example, equal to 25 mm. The section of the support 50 is constant along its length. This length can in particular be comprised between 1000 and 1300 mm; it is for example equal to 1178 mm.

Channels, the hydraulic diameter of which is generally comprised between 4 and 6 mm, for example between 4.5 and 5.5 mm, pass through the support 50, along all its length in the direction of the axis X-X, their number being, preferably, comprised between 8 and 12.

The channels are separated from each other by partitions generally designated by the reference 54. The channels along with the external cylindrical lateral surface of the support delimit peripheral walls 56.

All the channels are separated from the periphery of the support only by a single lateral wall 56. Thus, the fluid circulating in each channel can reach the external surface of the support by circulating only radially through a lateral wall, without having to follow an intermediate partition 54.

All the channels of the support have a section with an oblong shape, i.e. this section is generally extended and therefore has a length greater than its width.

All the channels are distributed in a first set of radial channels 62 arranged with their length extending radially and a second set of lateral channels 64 inserted between the radial channels at the periphery of the support and arranged with their length extending generally parallel to the periphery of the support.

In an advantageous manner, no channel is arranged along the axis X-X.

The radial channels 62 are regularly and angularly distributed around the axis X-X. Their number is preferably comprised, between four and six. In the example considered, it is five, so that the lengths of the sections of the channels are offset angularly by 72°.

The lateral channels 64 are inserted between the radial channels 62. Thus, each lateral channel 64 is centred on a bisecting line of the angle defined by the lengths of the sections of the radial channels 62. The lengths of the lateral channels 64 extend along the sides of a pentagon centred along the axis X-X.

In the embodiment considered, all the channels have the same section. The surface area of the cross section of the channels is preferably comprised between 18 mm² and 30 mm². Here it is 23 mm².

The section of the channels has an ellipsoidal shape. The major axis of the ellipse has a length greater than half of the radius of the support 50. Preferably, this length is substantially equal to two thirds of the radius of the support. The length of the minor axis of the ellipse, i.e. the width of the channel, is comprised between one third and two thirds of the length of the major axis. Preferably, this is equal to substantially half of the length of the major axis.

Generally, the radial channels have a width comprised between 0.3 and 0.6 times their length.

Preferably, the minimum thickness of the lateral walls 56 is equal to 1.5 mm while the minimum thickness of the partitions 56 between the adjacent channels is equal to 0.8 mm.

With such a support, the diameter of which in this case is equal to 25 mm and the length of which in this case is equal to 1178 mm, the following characteristics are obtained:
total surface area of the channels: 0.230 m²; and
hydraulic diameter: 4.9 mm.

The particular arrangement of the channels makes it possible to obtain a significant expanded filtering surface with a hydraulic diameter of the order of 5, which allows the filtration of fluids which are relatively viscous or loaded with matter in suspension.

FIG. 3 shows a variant embodiment of the support of FIG. 2. In the remainder of the description, the partitions and the lateral walls are designated by the same references 54 and 56.

As previously, the support referenced 70 has a cylindrical shape with a 25 mm diameter. It defines five radial channels 72 between which five longitudinal channels 74 are inserted along the external lateral surface.

All the channels have the same shape. Thus, the section of the channels has a curvilinear triangular shape having a large convex side 76 and two small sides 78 which are smaller and concave. The sides 78 have identical lengths.

The sides delimiting the channels are connected to each other by fillets.

For the lateral channels, the large convex side 76 extends substantially parallel to the external cylindrical surface of the support. The radius of curvature of this large side 76 is equal to 22 mm and the centre extends along the axis X-X of the support. The large sides 76 extend in the extension of each other and thus have the same circular envelope.

The small concave sides 78 have a radius of curvature of 12.3 mm. The angles of the curved triangle have fillets the radius of which is equal to 0.7 mm for the fillets formed at the ends of the large side 76 and to 1.3 mm for the fillet connecting the two small sides 78.

Thus, each conduit has a transverse section the perimeter of which is equal to 20.5 mm and the surface area of which is equal to 23.5 mm².

The length of the sections of the channels is approximately 8.8 mm in this case. The radial channels extend with their length generally arranged from the centre towards the periphery. This length extends essentially radially, being slightly inclined, the latter delimiting with one diameter of the support an angle of some twenty degrees. All the radial channels 72 are inclined relative to the associated diameter of the same side in the manner of the blades of a propeller. They are arranged in the same direction and are regularly and angularly distributed such that the pattern defined by the channels is invariant by rotation around the axis of the support by an angle of 72°.

Preferably, in this embodiment, the minimum thickness of the lateral walls 56 separating the large sides 76 of the lateral channels of the external surface of the support is equal to 1.5 mm, while the minimum thickness of the partitions 34 separating the radial channels from the longitudinal channels is equal to 1.2 mm.

In an advantageous manner, no channel is arranged along the axis X-X.

The partitions 54 delimited between the different channels have the general shape of a Y.

The filtering surface area of such a support with a 28.8 mm diameter and with a length equal to 1178 mm is equal to 0.240 m² for a hydraulic diameter of 4.65 mm.

In the embodiment of FIG. 4, the radial channels referenced 92 and the lateral channels referenced 94 have different shapes. The radial channels 92 extend with their length arranged exactly radially. These channels, five in number, are offset angularly by 72°. In section they have a polygonal shape with more than four sides, this number being in particular equal to five, such that these channels have an irregular pentagon shape. The section of the radial channels is symmetrical relative to the length of the channels. They have, extending from the centre of the support two small sides 96. For two adjacent radial channels 92, these small sides extend parallel to each other, such that the partitions 54 separating the channels in the vicinity of the centre define a star with five branches.

Along the external surface of the support, each radial channel 92 has a narrow side forming a bottom 98 extending generally parallel to the external surface of the support. This bottom is connected to the ends of the small sides by two large sides 100.

The length of the radial channels 92 is approximately equal to 9.3 mm in this case while their width, measured between the points connecting the small sides 96 to the large sides 100, is equal to 4.1 mm.

The longitudinal channels 94 have, in section, a curvilinear triangular shape having a curved base 102 extending generally parallel to the lateral surface of the support and two rectilinear sides 104 of the same length extending parallel to the large sides 100 of the two radial channels between which the longitudinal channel is inserted. The base 102 has a length greater than the rectilinear sides 104.

The length of the lateral channels is 7.8 mm while their width is 5 mm.

The partitions 54 delimited between the adjacent radial channels 92 and the interposed lateral channel 94 have the general shape of a Y, the thickness of the partitions being constant along each branch of the Y and for example approximately equal to 1.2 mm.

In an advantageous manner, no channel is arranged along the axis X-X.

The thickness of the walls 56 separating the channels of the external surface is equal to 1.8 mm.

In all the channels, the successive sides delimiting the channels are connected to each other by fillets or rounded square angles.

With such a geometry, the porous support, having a diameter of 25 mm for a length of 1178 mm, provides a generated filtering surface area of 0.245 m², the hydraulic diameter of the radial channels 92 being equal to 4.83 mm while it is 4.81 mm for the lateral channels 94.

The porous supports illustrated in FIGS. 2, 3 and 4 comprise channels which are disjoint or not connected each other. Thus, the radial channels are totally separated from the lateral channels by continuous partitions.

In the variant embodiments illustrated in FIGS. 5 to 8, by contrast, a connecting passage connects two-by-two an adjacent radial channel and lateral channel in order to ensure the fluid communication between these channels. This connecting passage is relatively short and in particular preferably has a width less than half and preferably one third of the smallest length of the radial and lateral channels.

In FIGS. 5 to 8, the different elements of the supports corresponding to those of FIGS. 2 to 4 are designated by the same reference numbers.

In the embodiment of FIG. 5, the radial channels 62 and the lateral channels 64 are connected to each other from their tip by a connecting passage 120 situated in the vicinity of the periphery of the support.

Thus, each pair of radial and lateral channels thus connected defines in section a general V shape.

In the embodiment of FIG. 6, the adjacent radial and lateral channels are connected to each other from their corner situated closest to the periphery of the support by a passage 130. This connection is provided between two adjacent channels through an intermediate partition 54 delimited by two small concave sides 78 arranged facing each other.

In the embodiment of FIG. 7, the channels 92 and 94 are connected to each other by a connecting passage 140 provided through the partition 54 delimited between a large side 100 of a radial channel 92 and a rectilinear side 104 arranged facing a longitudinal channel 94.

In the embodiment of FIG. 7, the passage referenced 140 is provided in the half of the partition arranged close to the side of the periphery of the support.

By contrast, in the embodiment of FIG. 8, the passage referenced 150 is delimited through the same partition in its half arranged away from the periphery of the porous monolithic support 50.

With these variant embodiments, it is observed a particularly effective ratio of the hydraulic diameter to the membrane surface.

In a variant, the monolithic supports have a external section which is polygonal, in particular hexagonal or square. In this case, the dimensional relationships mentioned in the description apply through the replacement of the diameter of the support with the minimum transverse dimension of its section.

1. Porous monolithic support for a filtering element having a tubular shape and a substantially constant cross section along the direction of its axis and comprising a plurality of channels the surfaces of which are intended to be covered with filtration membranes, these channels having cross sections distributed in the cross section of the support, all the channels being separated from the periphery of the support only by a single lateral wall of the support, wherein the channels of the support are distributed in:
a first set of radial oblong channels arranged with their length extending substantially radially; and
a second set of lateral oblong channels inserted between the radial channels and arranged with their length extending substantially parallel to the periphery of the support
all the radial and lateral channels having the same shape.

2. Porous monolithic support according to claim 1, wherein the number of radial channels and lateral channels is comprised between 8 and 12.

3. Porous monolithic support according to claim 1, wherein the length of the radial channels is greater than a quarter of the minimum transverse dimension of the support.

4. Porous monolithic support according to claim 1, wherein the surface area of the cross-section of the radial and lateral channels is comprised between 18 and 30 mm².

5. Porous monolithic support according to claim 1 wherein the width of the radial channels is comprised between 0.3 and 0.6 times their length.

6. Porous monolithic support according to claim 1, wherein the minimum transverse dimension of the support is comprised between 24 mm and 30 mm, and in that the hydraulic diameter of each channel is comprised between 4 and 6 mm.

7. (canceled)

8. Porous monolithic support according to claim 1, wherein the radial channels have a section in the shape of an ellipse.

9. Porous monolithic support according to claim 1, wherein the radial channels have a section in the shape of a curvilinear triangle having a large convex side and two smaller concave sides.

10. Porous monolithic support according to claim 9, wherein the lateral channels are arranged such that the large convex sides of their section extend substantially parallel to the periphery of the support.

11. Porous monolithic support according to claim 1, wherein the radial channels have a polygonal shape with at least four sides, and in that the lateral channels have a generally triangular shape.

12. Porous monolithic support according to claim 1, wherein the channels are disjoint.

13. Porous monolithic support according to claim 1, wherein it comprises, for each pair of adjacent channels constituted by a radial channel and a lateral channel, a connecting passage ensuring communication between the associated radial and lateral channels.

14. Porous monolithic support according to claim 13, wherein each connecting passage has a width less than half of the smallest length of the channels.

15. Filtering element comprising a porous monolithic support delimiting a plurality of channels and filtration membranes covering the walls of the channels, wherein the porous monolithic support has a tubular shape and a substantially constant cross section along the direction of its axis and comprising a plurality of channels the surfaces of which are intended to be covered with the filtration membrane these channels having cross sections distributed in the cross section of the support, all the channels being separated from the periphery of the support only by a single lateral wall of the support, wherein all the channels of the support are distributed in:
a first set of radial oblong channels arranged with their length extending substantially radially; and
a second set of lateral oblong channels inserted between the radial channels and arranged with their length extending substantially parallel to the periphery of the support,
all the radial and lateral channels having the same shape.

16. (canceled)

17. Filtering element according to claim 15, wherein the radial channels have a section in the shape of an ellipse.

18. Filtering element according to claim 15, wherein the channels are disjoint.

19. Fluid filtration module comprising a set of filtration elements comprising a porous monolithic support delimiting a plurality of channels and filtration membranes covering the walls of the channels, wherein the porous monolithic support has a tubular shape and a substantially constant cross section along the direction of its axis and comprising a plurality of channels the surfaces of which are intended to be covered with the filtration membrane, these channels having cross sections distributed in the cross section of the support, all the channels being separated from the periphery of the support only by a single lateral wall of the support, wherein all the channels of the support are distributed in:
a first set of radial oblong channels arranged with their length extending substantially radially; and
a second set of lateral oblong channels inserted between the radial channels and arranged with their length extending substantially parallel to the periphery of the support,
all the radial and lateral channels having the same shape.

20. Fluid filtration module according to claim 19, wherein the radial channels have a section in the shape of an ellipse.

21. Fluid filtration module according to claim 19, wherein the channels are disjoint.
